(19) United States
(12) Patent Application Publication
(10) Pub. No.: US 2025/0351133 A1
(43) Pub. Date: Nov. 13, 2025

(54) TECHNIQUES FOR DYNAMIC SCHEDULING REQUEST PROCEDURES

(71) Applicant: QUALCOMM Incorporated, San Diego, CA (US)

(72) Inventors: Linhai HE, San Diego, CA (US); Sitaramanjaneyulu KANAMARLAPUDI, San Diego, CA (US); Gavin Bernard HORN, La Jolla, CA (US)

(21) Appl. No.: 18/656,854

(22) Filed: May 7, 2024

(51) Int. Cl. H04W 72/12

(52) U.S. Cl. CPC H04W 72/12

(57) ABSTRACT

Methods, systems, and devices for wireless communications are described. A user equipment (UE) may dynamically perform a scheduling request procedure based on multiple ranges associated with respective parameters of a set of parameters. For example, the UE may receive, from a network entity of a serving cell of the UE, signaling indicating a scheduling request configuration including an indication of multiple ranges associated with respective parameters of a set of parameters, the scheduling request configuration associated logical channels of a set of multiple logical channels of the UE. The UE may transmit, in accordance with the scheduling request configuration, a scheduling request for a first logical channel based on a first parameter satisfying a selected threshold, where the selected threshold is within a first range associated with the first parameter. The UE may monitor for a scheduling grant associated with the first logical channel based on the scheduling request.

### FIELD OF TECHNOLOGY

The following relates to wireless communications, including techniques for dynamic scheduling request procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). The UE may perform a scheduling request procedure to report a need for a scheduling grant or arrival of uplink data. The UE may perform the scheduling request procedure based on a scheduling request threshold.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE, transmitting, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter, and monitoring for a scheduling grant associated with the first logical channel based on the scheduling request.

A UE for wireless communications is described. The UE may include one or more memories storing processor executable code, and one or more processors coupled with the one or more memories. The one or more processors may individually or collectively be operable to execute the code to cause the UE to receive, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE, transmit, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter, and monitor for a scheduling grant associated with the first logical channel based on the scheduling request.

Another UE for wireless communications is described. The UE may include means for receiving, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE, means for transmitting, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter, and means for monitoring for a scheduling grant associated with the first logical channel based on the scheduling request.

A non-transitory computer-readable medium storing code for wireless communications is described. The code may include instructions executable by one or more processors to receive, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE, transmit, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter, and monitor for a scheduling grant associated with the first logical channel based on the scheduling request.

Some examples of the method, UEs, and non-transitory computer-readable medium described herein may further include operations, features, means, or instructions for performing a recovery procedure based on failure to receive the scheduling grant associated with the first logical channel and based on a traffic pattern, a radio condition at the UE, or both.

In some examples of the method, UEs, and non-transitory computer-readable medium described herein, the first range of the set of multiple ranges includes a range of quantities for a scheduling request count and the range of quantities for the scheduling request count may be based on a traffic pattern at the UE, a machine learning (ML) algorithm, or both.

In some examples of the method, UEs, and non-transitory computer-readable medium described herein, the first range of the set of multiple ranges includes a range of scheduling request prohibit timer durations and the range of scheduling request prohibit timer durations may be based on a traffic pattern at the UE, a ML algorithm, or both.

In some examples of the method, UEs, and non-transitory computer-readable medium described herein, the scheduling request for the first logical channel includes a predictive scheduling request and the scheduling request may be transmitted based on a traffic type, a periodicity of uplink traffic, or both at the UE.

In some examples of the method, UEs, and non-transitory computer-readable medium described herein, transmitting the scheduling request may include operations, features, means, or instructions for transmitting the scheduling request in accordance with a first type of data at the UE, a first type of activity at the UE of a set of multiple types of activities, or both, where: the first type of data includes uplink data, and the set of multiple types of activities include a beam failure recovery (BFR) procedure, a listen-before-talk (LBT) procedure, a delay status reporting (DSR) procedure, or any combination thereof.

In some examples of the method, UEs, and non-transitory computer-readable medium described herein, the scheduling request configuration may be associated with the one or more logical channels and a first bandwidth part (BWP) and the method, apparatuses, and non-transitory computer-readable medium may include further operations, features, means, or instructions for receiving, from the network entity of the serving cell of the UE, a second scheduling request configuration including a second indication of a second set of multiple ranges associated with the respective parameters of the set of parameters, the second scheduling request configuration associated one or more second logical channels of the set of multiple logical channels of the UE and a second BWP.

Some examples of the method, UEs, and non-transitory computer-readable medium described herein may further include operations, features, means, or instructions for selecting the selected threshold based on a traffic type of a traffic flow associated with the UE, a quality of service (QoS) flow indicator (QFI) of the traffic flow, one or more characteristics of a protocol data unit (PDU) set, or any combination thereof.

Some examples of the method, UEs, and non-transitory computer-readable medium described herein may further include operations, features, means, or instructions for selecting the first parameter of the set of parameters based on one or more traffic characteristics, a traffic pattern, a QoS flow, one or more radio conditions, or any combination thereof, where the first parameter includes: a scheduling request prohibit timer, a quantity of scheduling requests, a quantity of recovery procedures, a quantity of scheduling request skipping occasions, or any combination thereof.

In some examples of the method, UEs, and non-transitory computer-readable medium described herein, the first parameter of the set of parameters includes a scheduling request count and the method, apparatuses, and non-transitory computer-readable medium may include further operations, features, means, or instructions for transmitting, in accordance with the scheduling request configuration, a second scheduling request for the first logical channel based on the first parameter of the set of parameters satisfying a second selected threshold for the first parameter, where: the second selected threshold may be within the first range of the set of multiple ranges associated with the first parameter, the second selected threshold may be larger than the selected threshold, and the second selected threshold may be based on a QoS policy associated with a traffic flow of the UE.

Some examples of the method, UEs, and non-transitory computer-readable medium described herein may further include operations, features, means, or instructions for training a machine learning model based on one or more performance indicators and selecting the selected threshold based on the machine learning model.

Some examples of the method, UEs, and non-transitory computer-readable medium described herein may further include operations, features, means, or instructions for transmitting a message indicating an identifier of the scheduling request, a type of traffic, a range associated with a scheduling request prohibit timer, a range of quantities of scheduling request transmissions, or any combination thereof.

A method for wireless communications by a network entity is described. The method may include outputting signaling indicating a scheduling request configuration including an indication of a set of multiple ranges associated with respective parameters of a set of parameters, the scheduling request configuration associated one or more logical channels of a set of multiple logical channels of a UE and obtaining, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter.

A network entity for wireless communications is described. The network entity may include one or more memories storing processor executable code, and one or more processors coupled with the one or more memories. The one or more processors may individually or collectively be operable to execute the code to cause the network entity to output signaling indicating a scheduling request configuration including an indication of a set of multiple ranges associated with respective parameters of a set of parameters, the scheduling request configuration associated one or more logical channels of a set of multiple logical channels of a UE and obtain, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter.

Another network entity for wireless communications is described. The network entity may include means for outputting signaling indicating a scheduling request configuration including an indication of a set of multiple ranges associated with respective parameters of a set of parameters, the scheduling request configuration associated one or more logical channels of a set of multiple logical channels of a UE and means for obtaining, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter.

A non-transitory computer-readable medium storing code for wireless communications is described. The code may include instructions executable by one or more processors to output signaling indicating a scheduling request configuration including an indication of a set of multiple ranges associated with respective parameters of a set of parameters, the scheduling request configuration associated one or more logical channels of a set of multiple logical channels of a UE and obtain, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter.

In some examples of the method, network entities, and non-transitory computer-readable medium described herein, the first range of the set of multiple ranges includes a range of quantities for a scheduling request count and the range of quantities for the scheduling request count may be based on a traffic pattern at the UE, a ML algorithm, or both.

In some examples of the method, network entities, and non-transitory computer-readable medium described herein, the first range of the set of multiple ranges includes a range of scheduling request prohibit timer durations and the range of scheduling request prohibit timer durations may be based on a traffic pattern at the UE, a ML algorithm, or both.

In some examples of the method, network entities, and non-transitory computer-readable medium described herein, the scheduling request for the first logical channel includes a predictive scheduling request and the scheduling request may be obtained based on a traffic type, a periodicity of uplink traffic, or both at the UE.

In some examples of the method, network entities, and non-transitory computer-readable medium described herein, obtaining the scheduling request may include operations, features, means, or instructions for obtaining the scheduling request in accordance with a first type of data at the UE, a first type of activity at the UE of a set of multiple types of activities, or both, where: the first type of data includes uplink data, and the set of multiple types of activities include a BFR procedure, an LBT procedure, a DSR procedure, or any combination thereof.

In some examples of the method, network entities, and non-transitory computer-readable medium described herein, the scheduling request configuration may be associated with the one or more logical channels and a first BWP and the method, apparatuses, and non-transitory computer-readable medium may include further operations, features, means, or instructions for outputting a second scheduling request configuration including a second indication of a second set of multiple ranges associated with the respective parameters of the set of parameters, the second scheduling request configuration associated one or more second logical channels of the set of multiple logical channels of the UE and a second BWP.

In some examples of the method, network entities, and non-transitory computer-readable medium described herein, the first parameter of the set of parameters includes a scheduling request count and the method, apparatuses, and non-transitory computer-readable medium may include further operations, features, means, or instructions for obtaining, in accordance with the scheduling request configuration, a second scheduling request for the first logical channel based on the first parameter of the set of parameters satisfying a second selected threshold for the first parameter, where: the second selected threshold may be within the first range of the set of multiple ranges associated with the first parameter, the second selected threshold may be larger than the selected threshold, and the second selected threshold may be based on a QoS policy associated with a traffic flow of the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support techniques for dynamic scheduling request procedures in accordance with one or more aspects of the present disclosure.

FIG. 3 shows an example of a process flow that supports techniques for dynamic scheduling request procedures in accordance with one or more aspects of the present disclosure.

FIGS. 4 and 5 show block diagrams of devices that support techniques for dynamic scheduling request procedures in accordance with one or more aspects of the present disclosure.

FIG. 6 shows a block diagram of a communications manager that supports techniques for dynamic scheduling request procedures in accordance with one or more aspects of the present disclosure.

FIG. 7 shows a diagram of a system including a device that supports techniques for dynamic scheduling request procedures in accordance with one or more aspects of the present disclosure.

FIGS. 8 and 9 show block diagrams of devices that support techniques for dynamic scheduling request procedures in accordance with one or more aspects of the present disclosure.

FIG. 10 shows a block diagram of a communications manager that supports techniques for dynamic scheduling request procedures in accordance with one or more aspects of the present disclosure.

FIG. 11 shows a diagram of a system including a device that supports techniques for dynamic scheduling request procedures in accordance with one or more aspects of the present disclosure.

FIGS. 12 through 15 show flowcharts illustrating methods that support techniques for dynamic scheduling request procedures in accordance with one or more aspects of the present disclosure.

### DETAILED DESCRIPTION

Various aspects relate generally to wireless communication. Some aspects more specifically relate to scheduling request procedures. In some examples, a user equipment (UE) may perform a scheduling request procedure based on a scheduling request configuration. For example, the UE may receive the scheduling request configuration associated with one or more logical channels and including multiple ranges associated with different scheduling request parameters. The UE may select, from a range of the multiple ranges associated with a first parameter of the different scheduling request parameters, a threshold for the first parameter. As an example, one or more of the ranges may be ranges of scheduling request counts, such as quantities of scheduling requests transmitted by the UE. The UE may select the threshold as a scheduling request count within the range of scheduling request counts. After selecting the threshold, the UE may transmit a scheduling request for a logical channel of the one or more logical channels based on the parameter satisfying the selected threshold. The UE may monitor for a scheduling grant associated with the logical channel based on the scheduling request. For example, a network entity may output a scheduling grant to the UE based on the scheduling request.

Particular aspects of the subject matter described in this disclosure can be implemented to realize one or more of the following potential advantages. In some examples, by selecting the threshold from a range of thresholds and the parameter from multiple parameters, the described techniques can be used to improve a radio resource management (RRM) of the UE. For example, by including the range of thresholds and multiple parameters in the scheduling request configuration, the UE may have a greater level of flexibility associated with triggering the scheduling request procedure. The UE may dynamically select and apply thresholds, parameters, or both in response to a type of data at the UE, a type of activity at the UE, or both, which may improve the RRM of the UE compared to the scheduling request configuration indicating a single threshold for respective parameters, fewer parameters, or both.

Aspects of the disclosure are initially described in the context of wireless communications systems. Aspects of the disclosure are also described in the context of process flows. Aspects of the disclosure are further illustrated by and described with reference to apparatus diagrams, system diagrams, and flowcharts that relate to techniques for dynamic scheduling request procedures.

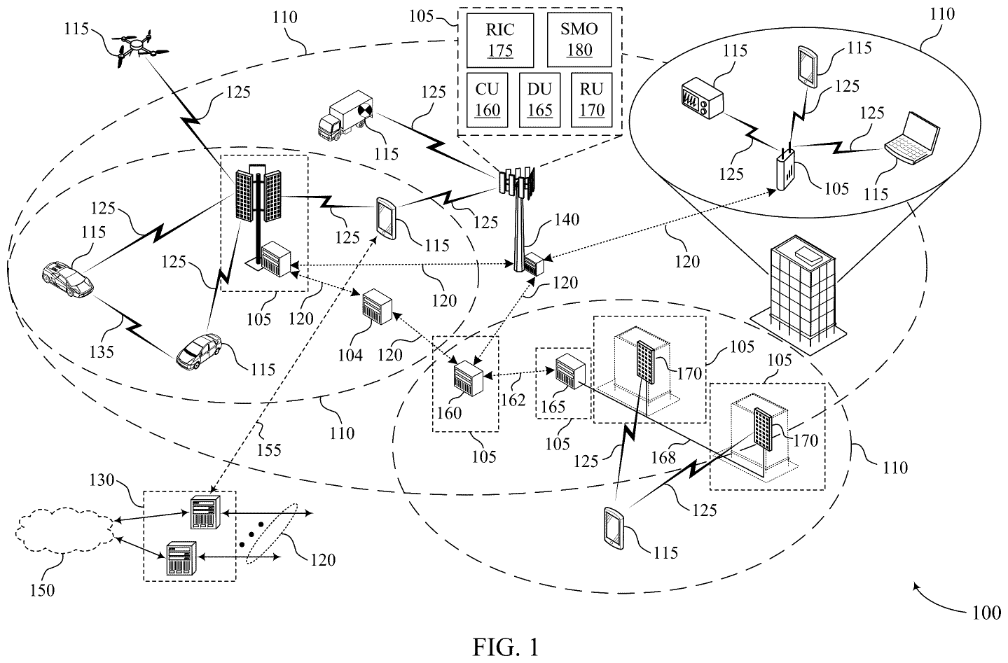

FIG. 1 shows an example of a wireless communications system 100 that supports techniques for dynamic scheduling request procedures in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), PDCP). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, the UE 115 may perform a scheduling request procedure according to a scheduling request configuration. For example, the UE 115 may receive, from the network entity 105 of a serving cell of the UE 115, signaling indicating a scheduling request configuration including an indication of a set of multiple ranges associated with respective parameters of a set of parameters, the scheduling request configuration associated one or more logical channels of a set of multiple logical channels of the UE 115. Based on the scheduling request configuration, the UE 115 may transmit a scheduling request for a first logical channel of the one or more logical channels based on a first parameter of the set of parameters satisfying a selected threshold. For example, the UE 115 may select the threshold from a range of thresholds associated with the first parameter. By selecting the threshold from the range of thresholds of the scheduling request configuration, the UE 115 may perform a dynamic scheduling request procedure and improve a RRM.

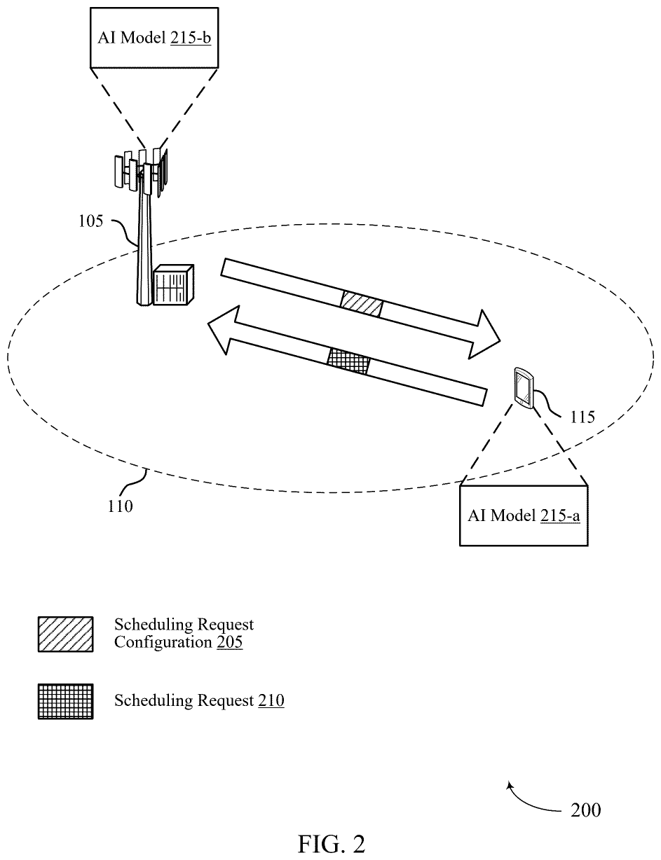

FIG. 2 shows an example of a wireless communications system 200 that supports techniques for dynamic scheduling request procedures in accordance with one or more aspects of the present disclosure. The wireless communications system 200 may implement or be implemented by various aspects of the wireless communications system 100. For example, the wireless communications system 200 may include a network entity 105 and a UE 115 in a coverage area 110, which may be examples of the network entity 105, the UE 115, and the coverage area 110, respectively, as described with reference to FIG. 1.

The wireless communications system 200 may support a scheduling request procedure. For example, the UE 115 may perform a scheduling request procedure to report a need for a scheduling grant or report arrival of uplink data (e.g., in a connected mode). In some examples, the UE 115 may perform the scheduling request procedure based on a scheduling request configuration 205. For example, the UE 115 may receive the scheduling request configuration 205 from the network entity 105. The scheduling request configuration 205 may indicate one or more physical uplink control channel (PUCCH) resources for one or more scheduling requests across one or more different BWPs, one or more cells, or both. Additionally, or alternatively, the scheduling request configuration 205 may correspond to one or more logical channels. That is, the UE 115 may receive different scheduling request configurations associated with different logical channels. As an example, the scheduling request configuration 205 may be a first scheduling request configuration and may correspond to one or more first logical channels, a second scheduling request configuration may correspond to one or more second logical channels, and so on. In other words, different logical channels may be mapped to respective scheduling request configurations.

In some examples, the different scheduling request configurations corresponding to the different logical channels may support respective Quality of Service (QoS) parameters (e.g., requirements) of traffic flows on the different logical channels. As an example, high-priority traffic on a logical channel may be associated with a scheduling request configuration including a relatively low scheduling request count, a prohibit timer with a relatively short duration (e.g., short periodicity), or both compared to other scheduling request configurations. Alternatively, or additionally, low-priority traffic on a logical channel may be associated with a scheduling request configuration including a relatively high scheduling request count, a prohibit timer with a relatively long duration (e.g., long periodicity), or both compared to one or more other scheduling request configurations. In other words, one or more scheduling request parameters included in the scheduling request configuration may be specific to one or more logical channels.

The scheduling request configuration 205 may support options to trigger the scheduling request procedure at the UE 115 based on traffic arrivals, such as an arrival of uplink data; based on procedures, such as a beam failure recovery (BFR) procedure or a delay status reporting (DSR) procedure; or both. In the example of the BFR procedure, the UE 115 may transmit a beam failure indication (e.g., via a MAC-control element (CE) (MAC-CE)) including preferred new beams. In order to transmit the beam failure indication, the UE 115 may trigger the scheduling request procedure to transmit a scheduling request 210 and, in response, obtain a scheduling grant from the network entity 105 to be used for transmission of the beam failure indication. In the example of the DSR procedure, the UE 115 may identify buffered data on a logical channel with a relatively low delay budget, and the UE 115 may trigger the scheduling request procedure to transmit the scheduling request 210 and, in response, obtain a scheduling grant from the network entity 105 to be used for transmission of the buffered data.

In some examples, the scheduling request configuration 205 may support a greater flexibility for the UE 115 to trigger a scheduling request compared to a scheduling request configuration including scheduling request parameters associated with a different procedure. The greater flexibility associated with the scheduling request configuration 205 may enable the UE 115 to request uplink grants sooner (e.g., when needed) and reduce a round-trip time (RTT), such as for a traffic flow or for a beam failure recovery. Additionally, or alternatively, the scheduling request configuration 205 may support a fallback mechanism in which the UE 115 may abandon (e.g., give up on) the scheduling request procedure and move to recovery procedure, such as a random access channel (RACH) procedure for cell access. For example, the UE 115 may select the fallback mechanism to avoid a long scheduling request transmission state.

The scheduling request configuration 205 may support the greater flexibility by including one or more ranges for one or more parameters associated with the scheduling request procedure. For example, the scheduling request configuration 205 may indicate a range of scheduling request counts (e.g., a minimum scheduling request count and a maximum scheduling request count). A scheduling request count may refer to a quantity of scheduling requests transmitted by the UE 115 prior to reception of a scheduling grant. In other words, the scheduling request count may refer to a quantity of transmissions of a same scheduling request by the UE 115. The UE 115 may select a scheduling request count threshold to apply based on a link quality. For example, the UE 115 may perform the fallback mechanism based on the scheduling request count threshold being satisfied. As an example, the UE 115 may select a relatively low scheduling request count threshold based on estimating a low link quality. The UE 115 may perform a radio link failure (RLF) operation based on the relatively low scheduling request count being satisfied. Alternatively, or additionally, the UE 115 may select a relatively high scheduling request count threshold based on estimating a high link quality. The UE 115 may continue to retransmit a scheduling request up to the relatively high scheduling request count threshold based on estimating the high link quality.

Additionally, or alternatively, the scheduling request configuration 205 may indicate a range of scheduling request prohibit timer durations (e.g., a minimum scheduling request prohibit timer duration and a maximum scheduling request prohibit timer duration). The UE 115 may, after transmitting the scheduling request 210, not transmit another scheduling request for the duration of the scheduling request prohibit timer. In other words, the UE 115 may refrain from transmitting another scheduling request for the duration of the scheduling request prohibit timer, which the UE 115 may start after transmission of a recent scheduling request, such as the scheduling request 210. In some examples, the UE 115 may select a duration of the scheduling request prohibit timer from the range of scheduling request prohibit timer durations based on a type of activity at the UE 115. As an example, the UE 115 may select a relatively short duration of the scheduling request prohibit timer (e.g., a minimum from the range) based on a BFR procedure at the UE 115. Alternatively, the UE 115 may select a relatively long duration of the scheduling request prohibit timer based on a data arrival from a low-priority logical channel. In other words, the UE 115 may prioritize or de-prioritize scheduling requests for different activities, such as BFR or data arrival, by selecting a duration of the scheduling request prohibit timer.

In some examples, the UE 115 may transmit one or more predictive scheduling requests based on the scheduling request configuration 205. For example, the UE 115 may transmit the scheduling request 210 prior to occurrence of a scheduling request triggering event, such as data arrival. As an example, the UE 115 may transmit the scheduling request 210 based on a type of traffic, such as transmission control protocol (TCP) in downlink, which may result in a TCP acknowledgement (ACK) in uplink. For example, the UE 115 may predict that TCP traffic is to be received in downlink and trigger the scheduling request procedure to prepare for transmission of the TCP ACK in uplink. As another example, the UE 115 may transmit the scheduling request 210 based on a periodicity of uplink traffic, which may be used to predict sending of a scheduling request 210. For example, the periodicity may be a known or estimated codec priority, predicted haptic traffic, or the like. Prior to a periodic uplink transmission, the UE 115 may trigger the scheduling request procedure to prepare for the periodic uplink transmission.

A granularity of the scheduling request configuration 205 may be per logical channel entity. That is, the one or more logical channels corresponding to the scheduling request configuration 205 may be a logical channel entity, where logical channel entities may include one or more logical channels. Additionally, or alternatively, the scheduling request configuration 205 may be specific to a BWP. The UE 115 may select a threshold from a range or a scheduling request parameter based on traffic within the BWP.

In some examples, the UE 115 may transmit the scheduling request 210 based on a QoS flow identifier (QFI) of a traffic flow, or based on one or more protocol data unit (PDU) set characteristics, or both. For example, the UE 115 may transmit the scheduling request 210 frequently (e.g., with a short periodicity) in examples in which the PDU set characteristics include a high level PDU session identity (PSI) compared to a low level PSI. As another example, the UE 115 may transmit the scheduling request 210 based on a PDU set delay budget (PSDB) or a PDU set error rate (PSER) associated with a PDU set. For example, the UE 115 may select a duration of a prohibit timer from the range indicated in the scheduling request configuration 205 according to the PSDB or the PSER associated with the PDU set.

In some examples, UE behavior may be adapted based on an AI/ML scheduler. In some cases, in addition to legacy triggers, the UE 115 may determine and trigger SRs autonomously, following SR occasions indicated in the scheduling request configuration 205. In an example, the UE 115 may dynamically trigger the scheduling request procedure. For example, UE 115 may dynamically trigger the scheduling request procedure based on a type of traffic, a traffic flow, or PDU set characteristics. The type of traffic may include data, voice, listen-before-talk (LBT), BFR, DSR, or a timing alignment request (TAR). The traffic flow may be related to the QoS or QFI of the traffic flow. For example, different types of traffic or different traffic flows may be associated with different priority levels. The UE 115 may select one or more scheduling request thresholds, one or more parameters, or both, from the scheduling request configuration 205 such that the scheduling request procedure is triggered more frequently for a higher priority traffic type or flow compared to a lower priority traffic type or flow. The PDU set characteristics may include the PSDB, the PSER, the PSI, a PDU set integrated handling indication (PSIHI), or the like. In some examples, the scheduling request configuration 205 may indicates a range associated with the PDU set characteristics, traffic type, traffic flow, or the like, that the UE 115 may select a value from the range and may trigger the scheduling request procedure (e.g., sending of the SR request) when the value is satisfied (e.g., PSDB is less than a selected value for a threshold for triggering the scheduling request procedure).

The UE 115 may dynamically select one or more scheduling request configuration parameters. For example, the UE 115 may select a prohibit timer, a maximum scheduling request count, to bail out from the scheduling request procedure (e.g., perform a fallback procedure, such as RACH), or skip scheduling request occasions. The UE 115 may select the scheduling request configuration parameters based on traffic characteristics, a traffic pattern, QoS parameters (e.g., requirements), radio conditions, and other service-specific inputs in addition to radio aspects.

The UE 115 may dynamically trigger the scheduling request procedure and dynamically select scheduling request configuration parameters to satisfy one or more different performance indicators (e.g., key performance indicators (KPIs)) based on one or more traffic characteristics, one or more radio conditions, or both. For example, the UE 115 may prolong the scheduling request procedure for one or more types of traffic based on a QoS requirement. That is, the UE 115 may select a high threshold scheduling request count such that the UE 115 may transmit scheduling requests for a relatively long duration to meet the QoS requirement. Alternatively, or additionally, the UE 115 may terminate or cancel the scheduling request procedure relatively early to move to a RACH procedure based on one or more traffic, one or more radio conditions, or both. For example, the UE 115 may select a low scheduling request count based on identifying poor traffic or radio conditions.

In some examples, the scheduling request procedure may take higher or lower precedence with respect to an overlapping PUSCH. For example, the UE 115 may prioritize or de-prioritize the scheduling request procedure by selecting one or more thresholds, one or more scheduling request parameters, or both, according to whether the scheduling request procedure takes precedence over the overlapping PUSCH. Additionally, or alternatively, the UE 115 may modify a selected scheduling request count (e.g., sr-TransMax count), a prohibit timer (e.g., sr-ProhibitTimer), or both based on traffic conditions, radio conditions, or both. In some examples, a DSR related SR configuration may be different compared to a TAR or another activity type based on one or more radio conditions, one or more grant patterns, or both. Additionally, or alternatively, the UE 115 may adapt one or more TAR triggering conditions (e.g., the threshold, the scheduling request parameter, etc.) based on whether the UE 115 is in a non-terrestrial network (NTN). For example, the UE 115 may adapt the TAR triggering conditions based on the network entity 105 being an NTN. As an example, the UE 115 may adapt the one or more TAR triggering conditions based on an offsetThresholdTA based on satellite coverage, one or more radio conditions, or both. In some examples, the UE 115 may modify one or more preemptive buffer status report (BSR) triggering conditions based on one or more IAB buffer capabilities, uplink shared channel (UL-SCH) availability, or both.

The UE 115 may use an artificial intelligence (AI) model 215-a to select the threshold, the scheduling request parameter, or both. For example, a behavior of the UE 115 may be adapted based on the AI model 215-a (e.g., an AI or machine learning (ML) scheduler) to meet one or more performance indicators (e.g., one or more KPIs). The one or more performance indicators may include a scheduling request success rate, a scheduling request termination criterion or criteria, scheduling request skipping based on latency thresholds (e.g., requirements), or any combination thereof. The UE 115 may input the one or more performance indicators to the AI model 215-a to train the model. Additionally, or alternatively, the UE 115 may report the one or more performance indicators to the network entity 105. For example, the network entity 105 may use the one or more performance indicators to train an AI model 215-b.

The UE 115 may transmit a feedback message to the network entity 105 indicating, for each scheduling request (e.g., for a scheduling request identifier), a scheduling request reason (e.g., beam failure detection (BFD), BFR, position (POS), LBT, BSR, DSR, etc.), a priority level of the scheduling request (e.g., high or low), a range associated with a prohibit timer (e.g., a minimum and maximum), a range associated with a scheduling request transmission count (e.g., a minimum and maximum), or the like.

Additionally, or alternatively, the UE 115 may report a scheduling request count and associated link quality. For example, the UE 115 may report a threshold quantity of scheduling request transmissions (e.g., a maximum scheduling request count) and an associated link quality measurement, such as a reference signal received power (RSRP). In some examples, the UE 115 may report multiple threshold quantities of scheduling request transmissions and link quality measurements associated with different scheduling requests.

In some examples, control data, such as included in one or more information elements (IEs), may be collected to support the AI/ML model, where the control data may include one or more labels such as meta data, one or more timestamps, etc. In some examples, UE 115 may report control data, such as a defined count (e.g., Maximum number of scheduling request) with respect to a signal quality level (e.g., RSRP) to indicate a defined SR count (e.g., Optimal SR count) for success. In some cases, a different defined count may correspond to a different signal quality level (e.g., different maxSR count based on a respective RSRP value). In some examples, the UE 115 may report control data, such as a threshold duration of a prohibit timer (e.g., a maximum prohibit timer) to satisfy a threshold block error rate (BLER) of a traffic flow. For example, the UE 115 may report the threshold duration of the prohibit timer used to satisfy the BLER and an associated packet loss rate. In some examples, the UE 115 may refrain from dropping a PDCP packet based on a PDCP discard timer while waiting for a scheduling request prohibit timer across scheduling request attempts.

In some examples, the network entity 105 may determine one or more multiple ranges in the scheduling request configuration 205 based on receiving one or more reports from the UE 115. For example, the network entity 105 may modify a range of one or more scheduling request parameters in the scheduling request configuration 205 based on the one or more performance indicators, the feedback, the reported scheduling request count and associated link quality, the reported prohibit timer duration and associated packet loss rate, or the like, or any combination thereof. In some examples, the network entity 105 may modify the range based on the AI model 215-b.

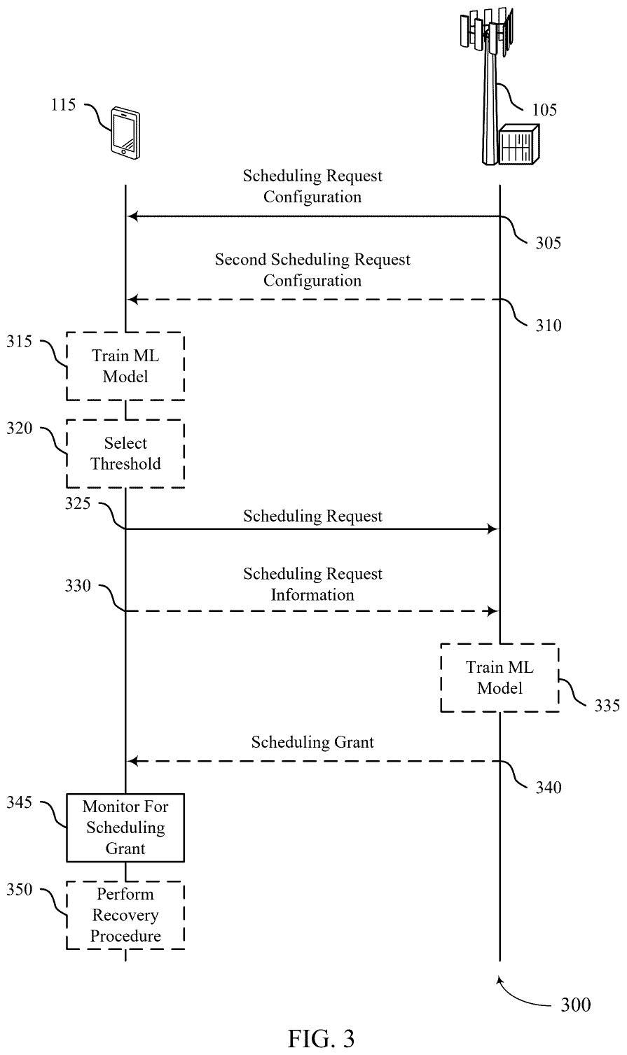

FIG. 3 shows an example of a process flow 300 that supports techniques for dynamic scheduling request procedures in accordance with one or more aspects of the present disclosure. In some examples, the process flow 300 may implement or be implemented by aspects of the wireless communications system 100, the wireless communications system 200, or both. For example, the process flow 300 may include a network entity 105 and a UE 115, which may be examples of corresponding devices as illustrated by and described with reference to FIGS. 1 and 2.

Alternative examples of the following may be implemented. Some operations are performed in a different order than described or are not performed at all. In some cases, operations may include additional features not mentioned below, or further operations may be added. Although the network entity 105 and the UE 115 are shown performing the operations of the process flow 300, some aspects of some operations may also be performed by one or more other wireless communication devices.

At 305, the network entity 105 may output a scheduling request configuration. For example, the UE 115 may receive, from the network entity 105 of a serving cell of the UE 115, signaling indicating the scheduling request configuration including an indication of multiple ranges associated with respective parameters of a set of parameters. In some examples, the scheduling request configuration may be associated with one or more logical channels of multiple logical channels of the UE 115. The scheduling request configuration may be an example of the scheduling request configuration 205 as described with reference to FIG. 2. In some examples, the scheduling request configuration may be associated with one or more logical channels and a first BWP.

At 310, the network entity 105 may output a second scheduling request configuration. For example, the UE 115 may receive a second scheduling request configuration including a second indication of second multiple ranges associated with the respective parameters of the set of parameters. The second scheduling request configuration may be associated with one or more second logical channels of the multiple logical channels of the UE 115 and a second BWP.

At 315, the UE 115 may train a ML model. For example, the UE 115 may train the ML model based on one or more performance indicators. The ML model may be an example of the AI model 215-a as described with reference to FIG. 2.

At 320, the UE 115 may select a threshold. For example, the UE 115 may select a threshold for a first parameter of the set of parameters. The selected threshold may be within a first range associated with the first parameter of the multiple ranges indicated in the scheduling request configuration received at 305. In some examples, the UE 115 may select the threshold based on the machine learning model trained at 315.

In some examples, the first range of the multiple ranges may include a range of quantities for a scheduling request count, where the range of quantities for the scheduling request count is based on a traffic pattern at the UE 115, a machine learning algorithm, or both. Additionally, or alternatively, the first range of the plurality of ranges may include a range of scheduling request prohibit timer durations, where the range of scheduling request prohibit timer durations is based on a traffic pattern at the UE, a machine learning algorithm, or both. For example, the network entity 105 may determine the ranges for the quantities for the scheduling request count, scheduling request prohibit timer durations, or both based on information from the UE 115.

In some examples, the UE 115 may select the threshold based on a traffic type of a traffic flow associated with the UE 115, a QFI of the traffic flow, one or more characteristics of a PDU set, or any combination thereof. Additionally, or alternatively, the UE 115 may select the first parameter. For example, the UE 115 may select the first parameter of the set of parameters based on one or more traffic characteristics, a traffic pattern, a QoS flow, one or more radio conditions, or any combination thereof. The first parameter may include a scheduling request prohibit timer, a quantity of scheduling requests, a quantity of recovery procedures, a quantity of scheduling request skipping occasions, or any combination thereof.

At 325, the UE 115 may transmit a scheduling request. For example, the UE 115 may transmit, in accordance with the scheduling request configuration, a scheduling request for a first logical channel of the one or more logical channels based on the first parameter of the set of parameters satisfying the selected threshold for the first parameter. The UE 115 may transmit the scheduling request based on selecting the threshold at 320.

In some examples, the scheduling request for the first logical channel may include a predictive scheduling request. For example, the UE 115 may transmit the scheduling request based on a traffic type, a periodicity of uplink traffic, or both at the UE 115. As an example, the UE 115 may transmit the predictive scheduling request based on an upcoming periodic transmission. Additionally, or alternatively, the UE 115 may transmit the scheduling request in accordance with a first type of data at the UE 115, a first type of activity at the UE 115 of multiple types of activities, or both. For example, the first type of data may include uplink data, and the multiple types of activities may include a BFR procedure, a LBT procedure, a DSR procedure, or the like.

In some examples, the UE 115 may transmit a second scheduling request. For example, in examples in which the first parameter includes a scheduling request count, the UE 115 may transmit, in accordance with the scheduling request configuration, a second scheduling request for the first logical channel based on the first parameter of the set of parameters satisfying a second selected threshold for the first parameter. The second selected threshold may be within the first range of the plurality of ranges associated with the first parameter, larger than the selected threshold from 320, and based on a QoS policy associated with a traffic flow of the UE 115. In other words, the UE 115 may prolong a scheduling request procedure by increasing a scheduling request count threshold to satisfy a QoS policy.

At 330, the UE 115 may transmit scheduling request information. For example, the UE 115 may transmit a message indicating an identifier of the scheduling request, a type of traffic, a range associated with a scheduling request prohibit timer, a range of quantities of scheduling request transmissions, or any combination thereof. In some examples, the UE 115 may transmit the scheduling request information in a scheduling request report, a feedback message, or the like.

At 335, the network entity 105 may train a ML model. For example, the network entity 105 may train the ML model based on the scheduling request information obtained at 330. The ML model may be an example of the AI model 215-b as described with reference to FIG. 2. The network entity 105 may determine one or more of the multiple ranges indicated in the scheduling request configuration based on the ML model. That is, the network entity 105 may update (e.g., iteratively) the scheduling request configuration based on feedback from the UE 115.

At 340, the network entity 105 may output a scheduling grant. For example, the network entity 105 may output the scheduling grant based on receiving the scheduling request at 325. The scheduling grant may include resources to be used by the UE 115 to transmit data based on the scheduling request. At 345, the UE 115 may monitor for a scheduling grant. For example, the UE 115 may monitor for a scheduling grant associated with the first logical channel based on the scheduling request transmitted at 325.

At 350, the UE 115 may perform a recovery procedure. For example, the UE 115 may perform the recovery procedure based on a failure to receive the scheduling grant associated with the first logical channel at 345 and based on a traffic pattern, a radio condition at the UE 115, or both. As an example, the UE 115 may perform the recovery procedure based on poor radio conditions, including poor link quality.

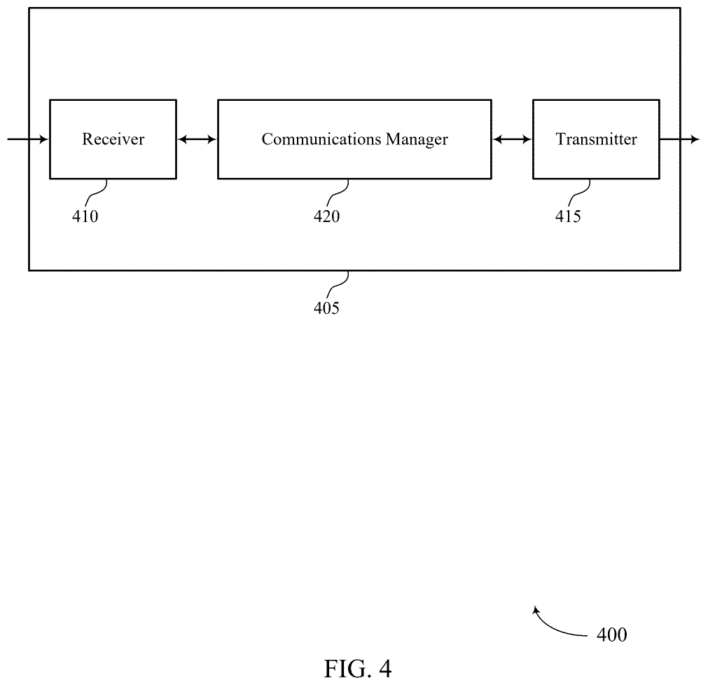

FIG. 4 shows a block diagram 400 of a device 405 that supports techniques for dynamic scheduling request procedures in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for dynamic scheduling request procedures). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for dynamic scheduling request procedures). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for dynamic scheduling request procedures as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE. The communications manager 420 is capable of, configured to, or operable to support a means for transmitting, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter. The communications manager 420 is capable of, configured to, or operable to support a means for monitoring for a scheduling grant associated with the first logical channel based on the scheduling request.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

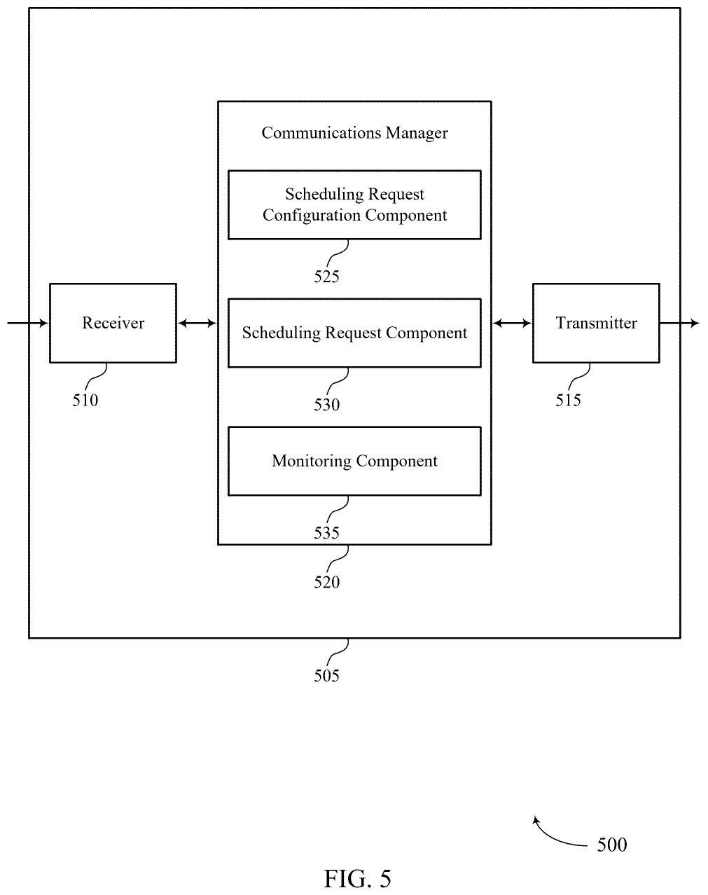

FIG. 5 shows a block diagram 500 of a device 505 that supports techniques for dynamic scheduling request procedures in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for dynamic scheduling request procedures). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for dynamic scheduling request procedures). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for dynamic scheduling request procedures as described herein. For example, the communications manager 520 may include a scheduling request configuration component 525, a scheduling request component 530, a monitoring component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The scheduling request configuration component 525 is capable of, configured to, or operable to support a means for receiving, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE. The scheduling request component 530 is capable of, configured to, or operable to support a means for transmitting, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter. The monitoring component 535 is capable of, configured to, or operable to support a means for monitoring for a scheduling grant associated with the first logical channel based on the scheduling request.

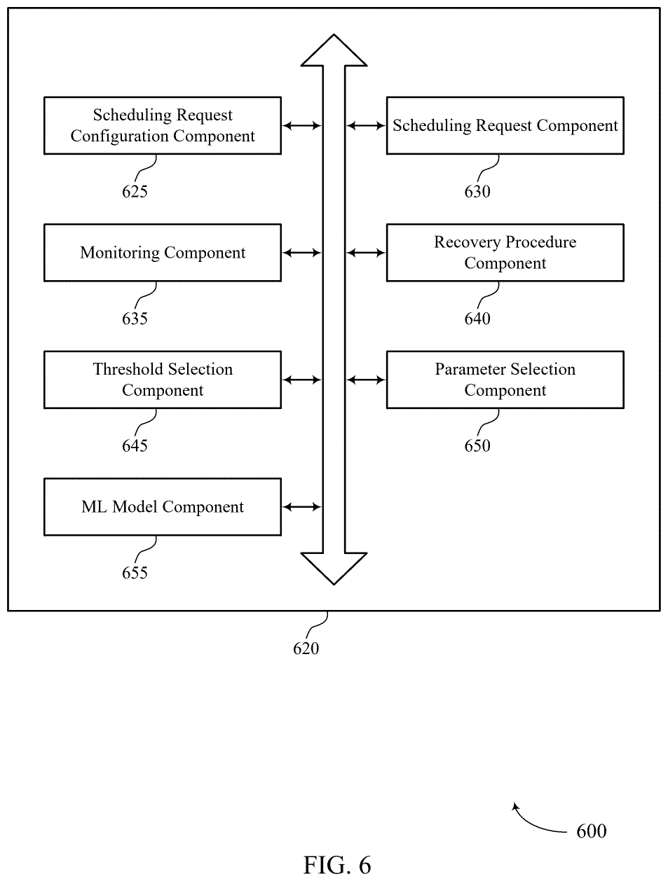

FIG. 6 shows a block diagram 600 of a communications manager 620 that supports techniques for dynamic scheduling request procedures in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for dynamic scheduling request procedures as described herein. For example, the communications manager 620 may include a scheduling request configuration component 625, a scheduling request component 630, a monitoring component 635, a recovery procedure component 640, a threshold selection component 645, a parameter selection component 650, an ML model component 655, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The scheduling request configuration component 625 is capable of, configured to, or operable to support a means for receiving, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE. The scheduling request component 630 is capable of, configured to, or operable to support a means for transmitting, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter. The monitoring component 635 is capable of, configured to, or operable to support a means for monitoring for a scheduling grant associated with the first logical channel based on the scheduling request.

In some examples, the recovery procedure component 640 is capable of, configured to, or operable to support a means for performing a recovery procedure based on failure to receive the scheduling grant associated with the first logical channel and based on a traffic pattern, a radio condition at the UE, or both.

In some examples, the first range of the set of multiple ranges includes a range of quantities for a scheduling request count. In some examples, the range of quantities for the scheduling request count is based on a traffic pattern at the UE, a machine learning algorithm, or both.

In some examples, the first range of the set of multiple ranges includes a range of scheduling request prohibit timer durations. In some examples, the range of scheduling request prohibit timer durations is based on a traffic pattern at the UE, a machine learning algorithm, or both.

In some examples, the scheduling request for the first logical channel includes a predictive scheduling request. In some examples, the scheduling request is transmitted based on a traffic type, a periodicity of uplink traffic, or both at the UE.

In some examples, to support transmitting the scheduling request, the scheduling request component 630 is capable of, configured to, or operable to support a means for transmitting the scheduling request in accordance with a first type of data at the UE, a first type of activity at the UE of a set of multiple types of activities, or both, where: the first type of data includes uplink data, and the set of multiple types of activities include a BFR procedure, an LBT procedure, a DSR procedure, or any combination thereof.

In some examples, the scheduling request configuration is associated with the one or more logical channels and a first BWP, and the scheduling request configuration component 625 is capable of, configured to, or operable to support a means for receiving, from the network entity of the serving cell of the UE, a second scheduling request configuration including a second indication of a second set of multiple ranges associated with the respective parameters of the set of parameters, the second scheduling request configuration associated one or more second logical channels of the set of multiple logical channels of the UE and a second BWP.

In some examples, the threshold selection component 645 is capable of, configured to, or operable to support a means for selecting the selected threshold based on a traffic type of a traffic flow associated with the UE, a QFI of the traffic flow, one or more characteristics of a PDU set, or any combination thereof.

In some examples, selecting the first parameter of the set of parameters based on one or more traffic characteristics, a traffic pattern, a QoS flow, one or more radio conditions, or any combination thereof, where the first parameter includes: a scheduling request prohibit timer, a quantity of scheduling requests, a quantity of recovery procedures, a quantity of scheduling request skipping occasions, or any combination thereof.

In some examples, the first parameter of the set of parameters includes a scheduling request count, and the scheduling request component 630 is capable of, configured to, or operable to support a means for transmitting, in accordance with the scheduling request configuration, a second scheduling request for the first logical channel based on the first parameter of the set of parameters satisfying a second selected threshold for the first parameter, where: the second selected threshold is within the first range of the set of multiple ranges associated with the first parameter, the second selected threshold is larger than the selected threshold, and the second selected threshold is based on a QoS policy associated with a traffic flow of the UE.

In some examples, the ML model component 655 is capable of, configured to, or operable to support a means for training a machine learning model based on one or more performance indicators. In some examples, the threshold selection component 645 is capable of, configured to, or operable to support a means for selecting the selected threshold based on the machine learning model.

In some examples, the scheduling request component 630 is capable of, configured to, or operable to support a means for transmitting a message indicating an identifier of the scheduling request, a type of traffic, a range associated with a scheduling request prohibit timer, a range of quantities of scheduling request transmissions, or any combination thereof.

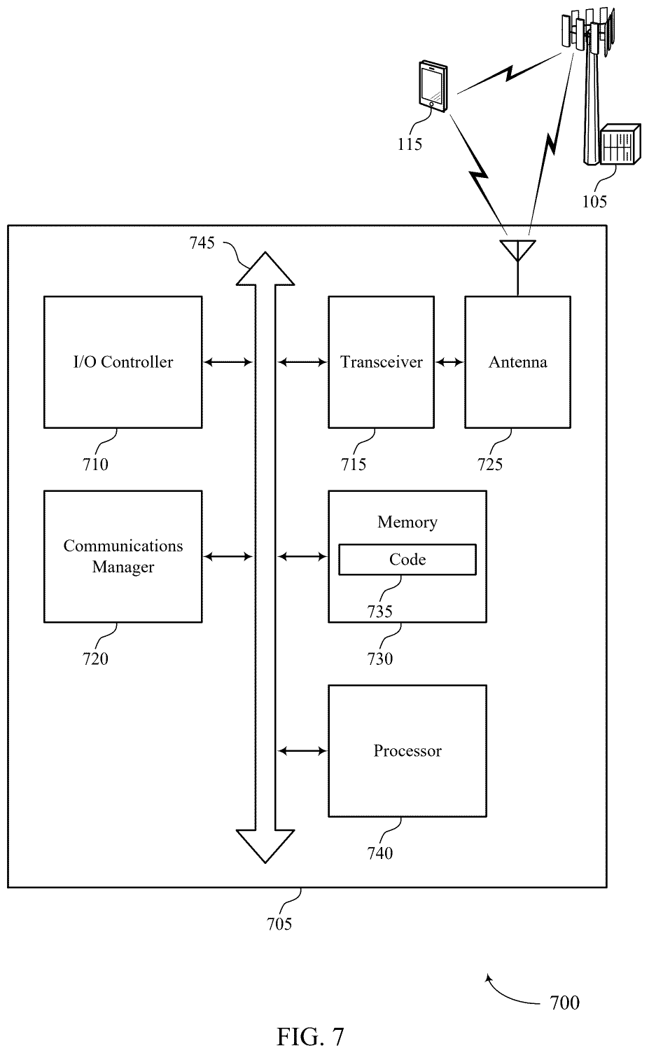

FIG. 7 shows a diagram of a system 700 including a device 705 that supports techniques for dynamic scheduling request procedures in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for dynamic scheduling request procedures). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE. The communications manager 720 is capable of, configured to, or operable to support a means for transmitting, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter. The communications manager 720 is capable of, configured to, or operable to support a means for monitoring for a scheduling grant associated with the first logical channel based on the scheduling request.

By including or configuring the communications manager 720 in accordance with examples as described herein, the device 705 may support techniques for improved communication reliability, reduced latency, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for dynamic scheduling request procedures as described herein, or the at least one processor 740 and the at least one memory 730 may be otherwise configured to, individually or collectively, perform or support such operations.

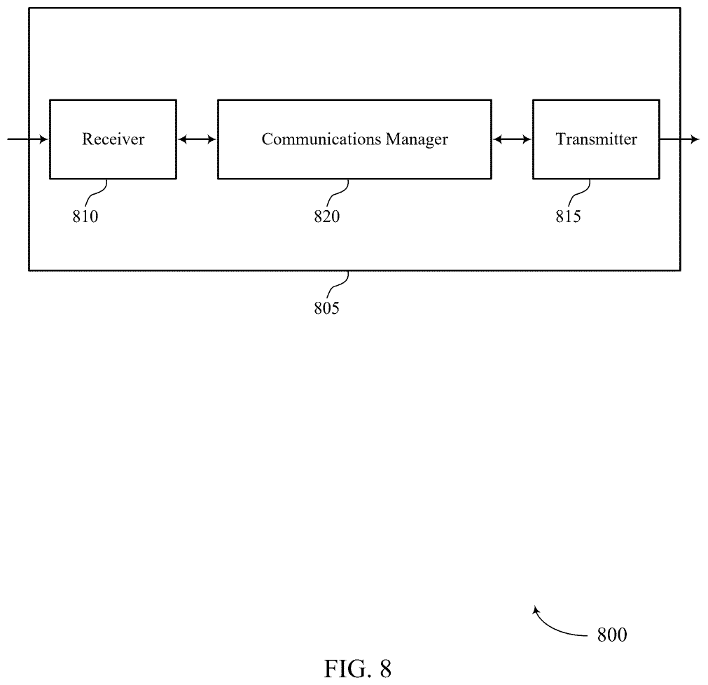

FIG. 8 shows a block diagram 800 of a device 805 that supports techniques for dynamic scheduling request procedures in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for dynamic scheduling request procedures as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting signaling indicating a scheduling request configuration including an indication of a set of multiple ranges associated with respective parameters of a set of parameters, the scheduling request configuration associated one or more logical channels of a set of multiple logical channels of a UE. The communications manager 820 is capable of, configured to, or operable to support a means for obtaining, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

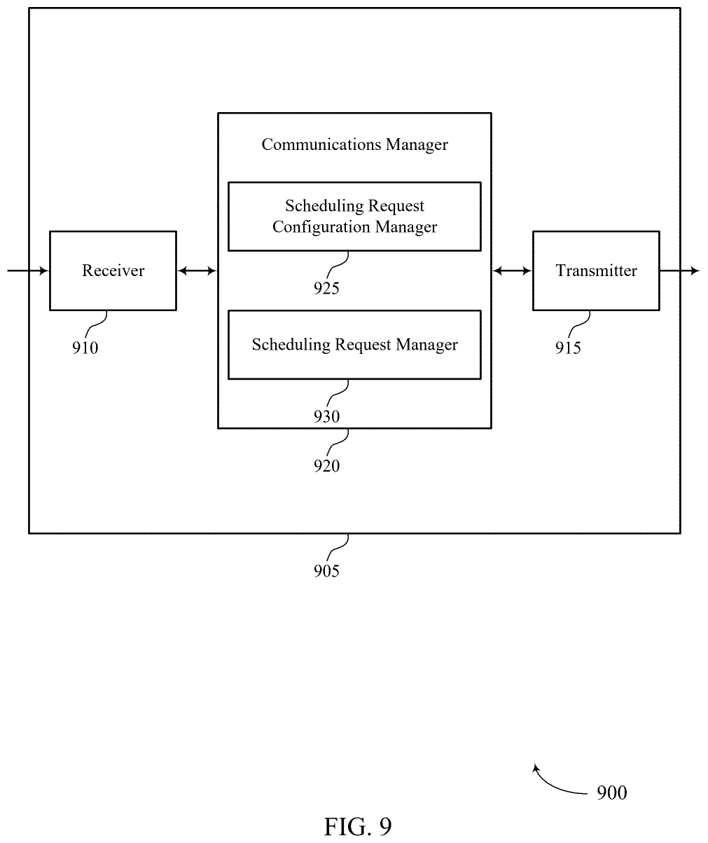

FIG. 9 shows a block diagram 900 of a device 905 that supports techniques for dynamic scheduling request procedures in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for dynamic scheduling request procedures as described herein. For example, the communications manager 920 may include a scheduling request configuration manager 925 a scheduling request manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The scheduling request configuration manager 925 is capable of, configured to, or operable to support a means for outputting signaling indicating a scheduling request configuration including an indication of a set of multiple ranges associated with respective parameters of a set of parameters, the scheduling request configuration associated one or more logical channels of a set of multiple logical channels of a UE. The scheduling request manager 930 is capable of, configured to, or operable to support a means for obtaining, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter.

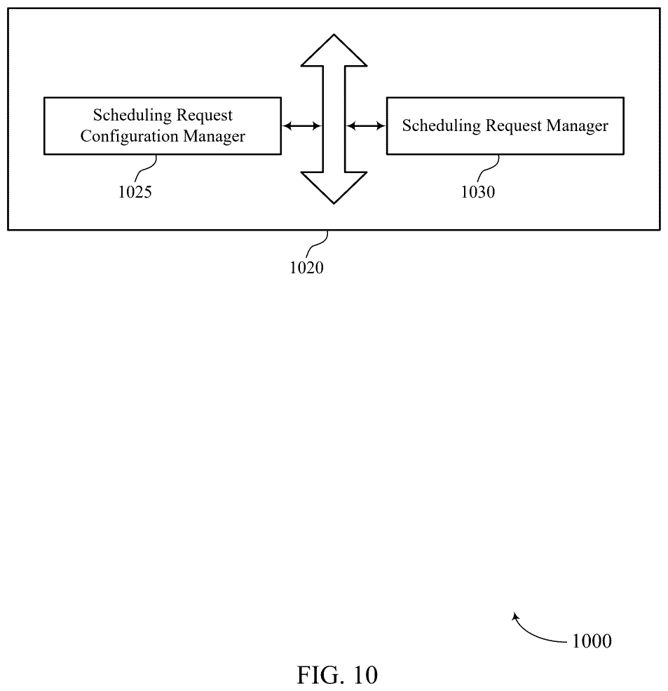

FIG. 10 shows a block diagram 1000 of a communications manager 1020 that supports techniques for dynamic scheduling request procedures in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for dynamic scheduling request procedures as described herein. For example, the communications manager 1020 may include a scheduling request configuration manager 1025 a scheduling request manager 1030, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The scheduling request configuration manager 1025 is capable of, configured to, or operable to support a means for outputting signaling indicating a scheduling request configuration including an indication of a set of multiple ranges associated with respective parameters of a set of parameters, the scheduling request configuration associated one or more logical channels of a set of multiple logical channels of a UE. The scheduling request manager 1030 is capable of, configured to, or operable to support a means for obtaining, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter.

In some examples, the first range of the set of multiple ranges includes a range of quantities for a scheduling request count. In some examples, the range of quantities for the scheduling request count is based on a traffic pattern at the UE, a machine learning algorithm, or both.

In some examples, the first range of the set of multiple ranges includes a range of scheduling request prohibit timer durations. In some examples, the range of scheduling request prohibit timer durations is based on a traffic pattern at the UE, a machine learning algorithm, or both.

In some examples, the scheduling request for the first logical channel includes a predictive scheduling request. In some examples, the scheduling request is obtained based on a traffic type, a periodicity of uplink traffic, or both at the UE.

In some examples, to support obtaining the scheduling request, the scheduling request manager 1030 is capable of, configured to, or operable to support a means for obtaining the scheduling request in accordance with a first type of data at the UE, a first type of activity at the UE of a set of multiple types of activities, or both, where: the first type of data includes uplink data, and the set of multiple types of activities include a BFR procedure, an LBT procedure, a DSR procedure, or any combination thereof.

In some examples, the scheduling request configuration is associated with the one or more logical channels and a first BWP, and the scheduling request configuration manager 1025 is capable of, configured to, or operable to support a means for outputting a second scheduling request configuration including a second indication of a second set of multiple ranges associated with the respective parameters of the set of parameters, the second scheduling request configuration associated one or more second logical channels of the set of multiple logical channels of the UE and a second BWP.

In some examples, the first parameter of the set of parameters includes a scheduling request count, and the scheduling request manager 1030 is capable of, configured to, or operable to support a means for obtaining, in accordance with the scheduling request configuration, a second scheduling request for the first logical channel based on the first parameter of the set of parameters satisfying a second selected threshold for the first parameter, where: the second selected threshold is within the first range of the set of multiple ranges associated with the first parameter, the second selected threshold is larger than the selected threshold, and the second selected threshold is based on a QoS policy associated with a traffic flow of the UE.

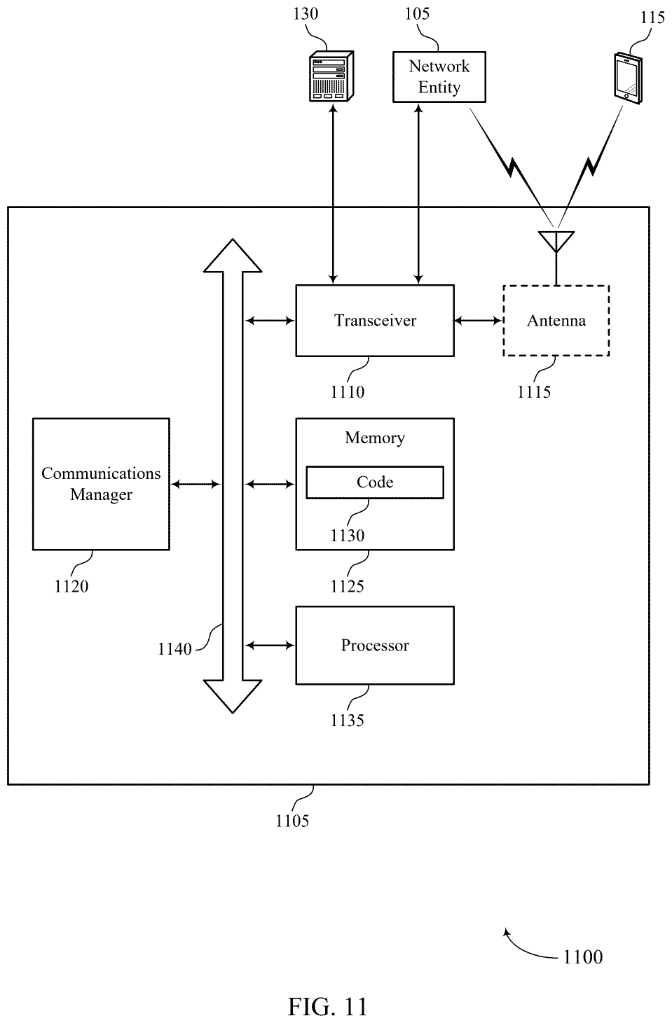

FIG. 11 shows a diagram of a system 1100 including a device 1105 that supports techniques for dynamic scheduling request procedures in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for dynamic scheduling request procedures). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting signaling indicating a scheduling request configuration including an indication of a set of multiple ranges associated with respective parameters of a set of parameters, the scheduling request configuration associated one or more logical channels of a set of multiple logical channels of a UE. The communications manager 1120 is capable of, configured to, or operable to support a means for obtaining, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter.

By including or configuring the communications manager 1120 in accordance with examples as described herein, the device 1105 may support techniques for improved communication reliability, reduced latency, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for dynamic scheduling request procedures as described herein, or the at least one processor 1135 and the at least one memory 1125 may be otherwise configured to, individually or collectively, perform or support such operations.

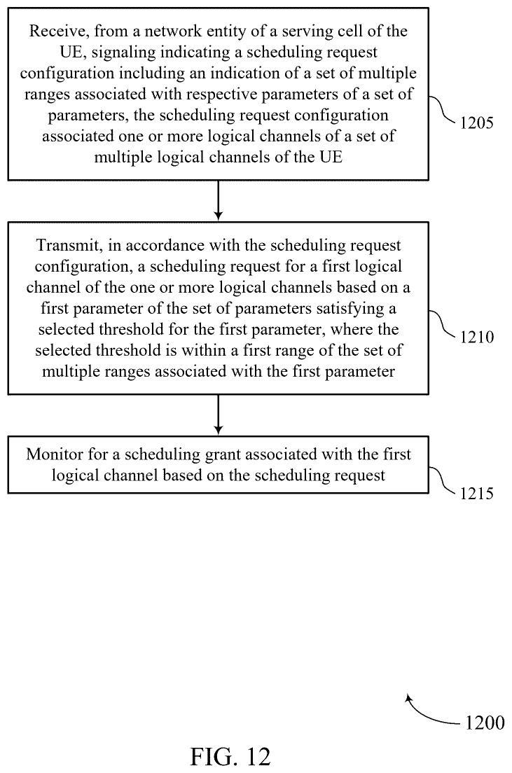

FIG. 12 shows a flowchart illustrating a method 1200 that supports

techniques for dynamic scheduling request procedures in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE. The operations of 1205 may be performed in accordance with examples as disclosed herein. In some examples, aspects of the operations of 1205 may be performed by a scheduling request configuration component 625 as described with reference to FIG. 6.

At 1210, the method may include transmitting, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter. The operations of 1210 may be performed in accordance with examples as disclosed herein. In some examples, aspects of the operations of 1210 may be performed by a scheduling request component 630 as described with reference to FIG. 6.

At 1215, the method may include monitoring for a scheduling grant associated with the first logical channel based on the scheduling request. The operations of 1215 may be performed in accordance with examples as disclosed herein. In some examples, aspects of the operations of 1215 may be performed by a monitoring component 635 as described with reference to FIG. 6.

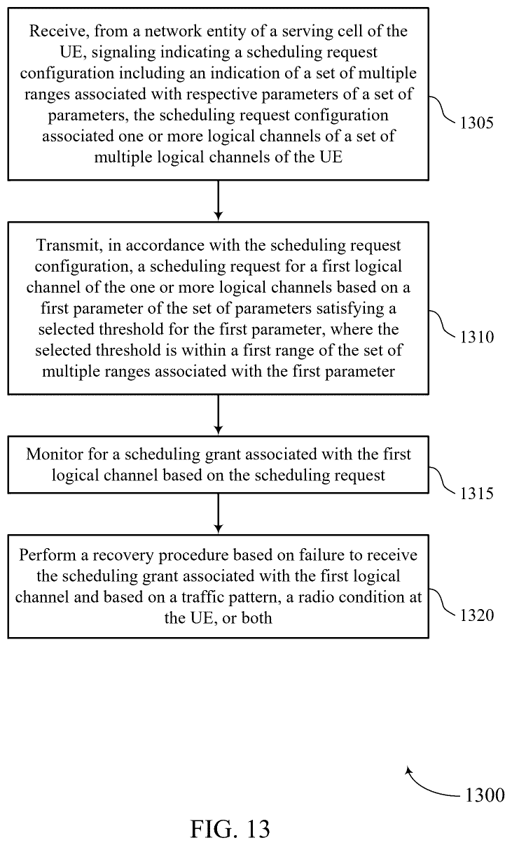

FIG. 13 shows a flowchart illustrating a method 1300 that supports techniques for dynamic scheduling request procedures in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity of a serving cell of the UE, signaling indicating a scheduling request configuration including an indication of a set of multiple ranges associated with respective parameters of a set of parameters, the scheduling request configuration associated one or more logical channels of a set of multiple logical channels of the UE. The operations of 1305 may be performed in accordance with examples as disclosed herein. In some examples, aspects of the operations of 1305 may be performed by a scheduling request configuration component 625 as described with reference to FIG. 6.

At 1310, the method may include transmitting, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter. The operations of 1310 may be performed in accordance with examples as disclosed herein. In some examples, aspects of the operations of 1310 may be performed by a scheduling request component 630 as described with reference to FIG. 6.

At 1315, the method may include monitoring for a scheduling grant associated with the first logical channel based on the scheduling request. The operations of 1315 may be performed in accordance with examples as disclosed herein. In some examples, aspects of the operations of 1315 may be performed by a monitoring component 635 as described with reference to FIG. 6.

At 1320, the method may include performing a recovery procedure based on failure to receive the scheduling grant associated with the first logical channel and based on a traffic pattern, a radio condition at the UE, or both. The operations of 1320 may be performed in accordance with examples as disclosed herein. In some examples, aspects of the operations of 1320 may be performed by a recovery procedure component 640 as described with reference to FIG. 6.

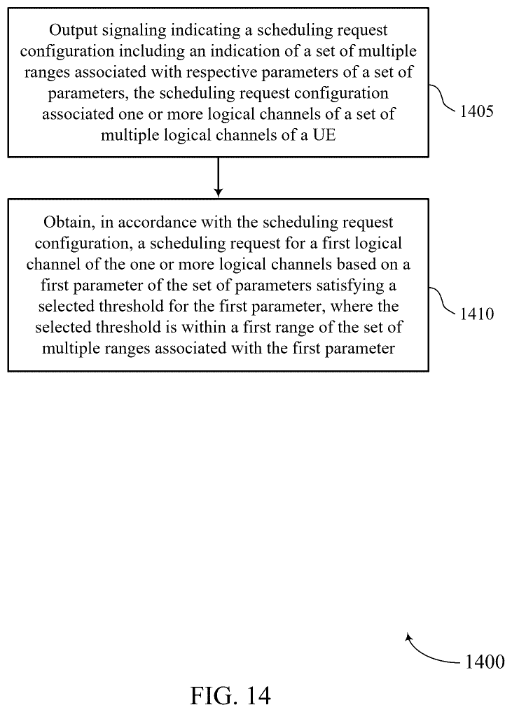

FIG. 14 shows a flowchart illustrating a method 1400 that supports techniques for dynamic scheduling request procedures in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting signaling indicating a scheduling request configuration including an indication of a set of multiple ranges associated with respective parameters of a set of parameters, the scheduling request configuration associated one or more logical channels of a set of multiple logical channels of a UE. The operations of 1405 may be performed in accordance with examples as disclosed herein. In some examples, aspects of the operations of 1405 may be performed by a scheduling request configuration manager 1025 as described with reference to FIG. 10.

At 1410, the method may include obtaining, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter. The operations of 1410 may be performed in accordance with examples as disclosed herein. In some examples, aspects of the operations of 1410 may be performed by a scheduling request manager 1030 as described with reference to FIG. 10.

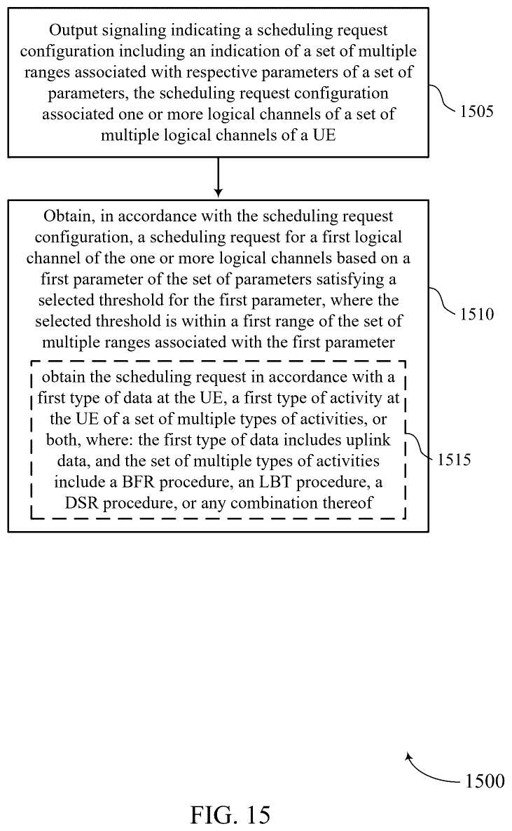

FIG. 15 shows a flowchart illustrating a method 1500 that supports techniques for dynamic scheduling request procedures in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting signaling indicating a scheduling request configuration including an indication of a set of multiple ranges associated with respective parameters of a set of parameters, the scheduling request configuration associated one or more logical channels of a set of multiple logical channels of a UE. The operations of 1505 may be performed in accordance with examples as disclosed herein. In some examples, aspects of the operations of 1505 may be performed by a scheduling request configuration manager 1025 as described with reference to FIG. 10.

At 1510, the method may include obtaining, in accordance with the scheduling request configuration, a scheduling request for a first logical channel of the one or more logical channels based on a first parameter of the set of parameters satisfying a selected threshold for the first parameter, where the selected threshold is within a first range of the set of multiple ranges associated with the first parameter. The operations of 1510 may be performed in accordance with examples as disclosed herein. In some examples, aspects of the operations of 1510 may be performed by a scheduling request manager 1030 as described with reference to FIG. 10.

At 1515, the method may include obtaining the scheduling request in accordance with a first type of data at the UE, a first type of activity at the UE of a set of multiple types of activities, or both, where: the first type of data includes uplink data, and the set of multiple types of activities include a BFR procedure, an LBT procedure, a DSR procedure, or any combination thereof. The operations of 1515 may be performed in accordance with examples as disclosed herein. In some examples, aspects of the operations of 1515 may be performed by a scheduling request manager 1030 as described with reference to FIG. 10.

The following provides an overview of aspects of the present disclosure:

Aspect 1: A method for wireless communications at a UE, comprising: receiving, from a network entity of a serving cell of the UE, signaling indicating a scheduling request configuration comprising an indication of a plurality of ranges associated with respective parameters of a set of parameters, the scheduling request configuration associated one or more logical channels of a plurality of logical channels of the UE; transmitting, in accordance with the scheduling request configuration, a scheduling request for a first logical channel of the one or more logical channels based at least in part on a first parameter of the set of parameters satisfying a selected threshold for the first parameter, wherein the selected threshold is within a first range of the plurality of ranges associated with the first parameter; and monitoring for a scheduling grant associated with the first logical channel based at least in part on the scheduling request.

Aspect 2: The method of aspect 1, further comprising: performing a recovery procedure based at least in part on failure to receive the scheduling grant associated with the first logical channel and based at least in part on a traffic pattern, a radio condition at the UE, or both.

Aspect 3: The method of any of aspects 1 through 2, wherein the first range of the plurality of ranges comprises a range of quantities for a scheduling request count, the range of quantities for the scheduling request count is based at least in part on a traffic pattern at the UE, a ML algorithm, or both.

Aspect 4: The method of any of aspects 1 through 3, wherein the first range of the plurality of ranges comprises a range of scheduling request prohibit timer durations, the range of scheduling request prohibit timer durations is based at least in part on a traffic pattern at the UE, a ML algorithm, or both.

Aspect 5: The method of any of aspects 1 through 4, wherein the scheduling request for the first logical channel comprises a predictive scheduling request, and the scheduling request is transmitted based at least in part on a traffic type, a periodicity of uplink traffic, or both at the UE.

Aspect 6: The method of any of aspects 1 through 5, wherein transmitting the scheduling request comprises: transmitting the scheduling request in accordance with a first type of data at the UE, a first type of activity at the UE of a plurality of types of activities, or both, wherein: the first type of data comprises uplink data, and the plurality of types of activities comprise a BFR procedure, an LBT procedure, a DSR procedure, or any combination thereof.

Aspect 7: The method of any of aspects 1 through 6, wherein the scheduling request configuration is associated with the one or more logical channels and a first BWP, the method further comprising: receiving, from the network entity of the serving cell of the UE, a second scheduling request configuration comprising a second indication of a second plurality of ranges associated with the respective parameters of the set of parameters, the second scheduling request configuration associated one or more second logical channels of the plurality of logical channels of the UE and a second BWP.

Aspect 8: The method of any of aspects 1 through 7, further comprising: selecting the selected threshold based at least in part on a traffic type of a traffic flow associated with the UE, a QFI of the traffic flow, one or more characteristics of a PDU set, or any combination thereof.

Aspect 9: The method of any of aspects 1 through 8, wherein selecting the first parameter of the set of parameters based at least in part on one or more traffic characteristics, a traffic pattern, a QoS flow, one or more radio conditions, or any combination thereof, wherein the first parameter comprises: a scheduling request prohibit timer, a quantity of scheduling requests, a quantity of recovery procedures, a quantity of scheduling request skipping occasions, or any combination thereof.

Aspect 10: The method of any of aspects 1 through 9, wherein the first parameter of the set of parameters comprises a scheduling request count, the method further comprising: transmitting, in accordance with the scheduling request configuration, a second scheduling request for the first logical channel based at least in part on the first parameter of the set of parameters satisfying a second selected threshold for the first parameter, wherein: the second selected threshold is within the first range of the plurality of ranges associated with the first parameter, the second selected threshold is larger than the selected threshold, and the second selected threshold is based at least in part on a QoS policy associated with a traffic flow of the UE.

Aspect 11: The method of any of aspects 1 through 10, further comprising: training a machine learning model based at least in part on one or more performance indicators; and selecting the selected threshold based at least in part on the machine learning model.

Aspect 12: The method of any of aspects 1 through 11, further comprising: transmitting a message indicating an identifier of the scheduling request, a type of traffic, a range associated with a scheduling request prohibit timer, a range of quantities of scheduling request transmissions, or any combination thereof.

Aspect 13: A method for wireless communications at a network entity, comprising: outputting signaling indicating a scheduling request configuration comprising an indication of a plurality of ranges associated with respective parameters of a set of parameters, the scheduling request configuration associated one or more logical channels of a plurality of logical channels of a UE; and obtaining, in accordance with the scheduling request configuration, a scheduling request for a first logical channel of the one or more logical channels based at least in part on a first parameter of the set of parameters satisfying a selected threshold for the first parameter, wherein the selected threshold is within a first range of the plurality of ranges associated with the first parameter.

Aspect 14: The method of aspect 13, wherein the first range of the plurality of ranges comprises a range of quantities for a scheduling request count, the range of quantities for the scheduling request count is based at least in part on a traffic pattern at the UE, a ML algorithm, or both.

Aspect 15: The method of any of aspects 13 through 14, wherein the first range of the plurality of ranges comprises a range of scheduling request prohibit timer durations, the range of scheduling request prohibit timer durations is based at least in part on a traffic pattern at the UE, a ML algorithm, or both.

Aspect 16: The method of any of aspects 13 through 15, wherein the scheduling request for the first logical channel comprises a predictive scheduling request, and the scheduling request is obtained based at least in part on a traffic type, a periodicity of uplink traffic, or both at the UE.

Aspect 17: The method of any of aspects 13 through 16, wherein obtaining the scheduling request comprises: obtaining the scheduling request in accordance with a first type of data at the UE, a first type of activity at the UE of a plurality of types of activities, or both, wherein: the first type of data comprises uplink data, and the plurality of types of activities comprise a BFR procedure, an LBT procedure, a DSR procedure, or any combination thereof.

Aspect 18: The method of any of aspects 13 through 17, wherein the scheduling request configuration is associated with the one or more logical channels and a first BWP, the method further comprising: outputting a second scheduling request configuration comprising a second indication of a second plurality of ranges associated with the respective parameters of the set of parameters, the second scheduling request configuration associated one or more second logical channels of the plurality of logical channels of the UE and a second BWP.

Aspect 19: The method of any of aspects 13 through 18, wherein the first parameter of the set of parameters comprises a scheduling request count, the method further comprising: obtaining, in accordance with the scheduling request configuration, a second scheduling request for the first logical channel based at least in part on the first parameter of the set of parameters satisfying a second selected threshold for the first parameter, wherein: the second selected threshold is within the first range of the plurality of ranges associated with the first parameter, the second selected threshold is larger than the selected threshold, and the second selected threshold is based at least in part on a QoS policy associated with a traffic flow of the UE.

Aspect 20: A UE for wireless communications, comprising one or more memories storing processor-executable code, and one or more processors coupled with the one or more memories and individually or collectively operable to execute the code to cause the UE to perform a method of any of aspects 1 through 12.

Aspect 21: A UE for wireless communications, comprising at least one means for performing a method of any of aspects 1 through 12.

Aspect 22: A non-transitory computer-readable medium storing code for wireless communications, the code comprising instructions executable by one or more processors to perform a method of any of aspects 1 through 12.

Aspect 23: A network entity for wireless communications, comprising one or more memories storing processor-executable code, and one or more processors coupled with the one or more memories and individually or collectively operable to execute the code to cause the network entity to perform a method of any of aspects 13 through 19.

Aspect 24: A network entity for wireless communications, comprising at least one means for performing a method of any of aspects 13 through 19.

Aspect 25: A non-transitory computer-readable medium storing code for wireless communications, the code comprising instructions executable by one or more processors to perform a method of any of aspects 13 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity of a serving cell of the UE, signaling indicating a scheduling request configuration comprising an indication of a plurality of ranges associated with respective parameters of a set of parameters, the scheduling request configuration associated one or more logical channels of a plurality of logical channels of the UE;
transmit, in accordance with the scheduling request configuration, a scheduling request for a first logical channel of the one or more logical channels based at least in part on a first parameter of the set of parameters satisfying a selected threshold for the first parameter, wherein the selected threshold is within a first range of the plurality of ranges associated with the first parameter; and
monitor for a scheduling grant associated with the first logical channel based at least in part on the scheduling request.

2. The UE of claim 1, wherein the one or more processors are individually or collectively further operable to execute the code to cause the UE to:
perform a recovery procedure based at least in part on failure to receive the scheduling grant associated with the first logical channel and based at least in part on a traffic pattern, a radio condition at the UE, or both.

3. The UE of claim 1, wherein:
the first range of the plurality of ranges comprises a range of quantities for a scheduling request count,
the range of quantities for the scheduling request count is based at least in part on a traffic pattern at the UE, a machine learning algorithm, or both.

4. The UE of claim 1, wherein:
the first range of the plurality of ranges comprises a range of scheduling request prohibit timer durations,
the range of scheduling request prohibit timer durations is based at least in part on a traffic pattern at the UE, a machine learning algorithm, or both.

5. The UE of claim 1, wherein:
the scheduling request for the first logical channel comprises a predictive scheduling request, and
the scheduling request is transmitted based at least in part on a traffic type, a periodicity of uplink traffic, or both at the UE.

6. The UE of claim 1, wherein, to transmit the scheduling request, the one or more processors are individually or collectively operable to execute the code to cause the UE to:
transmit the scheduling request in accordance with a first type of data at the UE, a first type of activity at the UE of a plurality of types of activities, or both, wherein: the first type of data comprises uplink data, and the plurality of types of activities comprise a beam failure recovery (BFR) procedure, a listen-before-talk (LBT) procedure, a delay status reporting (DSR) procedure, or any combination thereof.

7. The UE of claim 1, wherein the scheduling request configuration is associated with the one or more logical channels and a first bandwidth part (BWP), and the one or more processors are individually or collectively further operable to execute the code to cause the UE to:
receive, from the network entity of the serving cell of the UE, a second scheduling request configuration comprising a second indication of a second plurality of ranges associated with the respective parameters of the set of parameters, the second scheduling request configuration associated one or more second logical channels of the plurality of logical channels of the UE and a second BWP.

8. The UE of claim 1, wherein the one or more processors are individually or collectively further operable to execute the code to cause the UE to:
select the selected threshold based at least in part on a traffic type of a traffic flow associated with the UE, a quality of service (QoS) flow indicator (QFI) of the traffic flow, one or more characteristics of a protocol data unit (PDU) set, or any combination thereof.

9. The UE of claim 1, wherein selecting the first parameter of the set of parameters based at least in part on one or more traffic characteristics, a traffic pattern, a quality of service (QoS) flow, one or more radio conditions, or any combination thereof, wherein the first parameter comprises: a scheduling request prohibit timer, a quantity of scheduling requests, a quantity of recovery procedures, a quantity of scheduling request skipping occasions, or any combination thereof.

10. The UE of claim 1, wherein the first parameter of the set of parameters comprises a scheduling request count, and the one or more processors are individually or collectively further operable to execute the code to cause the UE to:
transmit, in accordance with the scheduling request configuration, a second scheduling request for the first logical channel based at least in part on the first parameter of the set of parameters satisfying a second selected threshold for the first parameter, wherein: the second selected threshold is within the first range of the plurality of ranges associated with the first parameter, the second selected threshold is larger than the selected threshold, and the second selected threshold is based at least in part on a quality of service (QoS) policy associated with a traffic flow of the UE.

11. The UE of claim 1, wherein the one or more processors are individually or collectively further operable to execute the code to cause the UE to:
train a machine learning model based at least in part on one or more performance indicators; and
select the selected threshold based at least in part on the machine learning model.

12. The UE of claim 1, wherein the one or more processors are individually or collectively further operable to execute the code to cause the UE to:
transmit a message indicating an identifier of the scheduling request, a type of traffic, a range associated with a scheduling request prohibit timer, a range of quantities of scheduling request transmissions, or any combination thereof.

13. A network entity, comprising:
one or more memories storing processor-executable code; and
one or more processors coupled with the one or more memories and individually or collectively operable to execute the code to cause the network entity to:
output signaling indicating a scheduling request configuration comprising an indication of a plurality of ranges associated with respective parameters of a set of parameters, the scheduling request configuration associated one or more logical channels of a plurality of logical channels of a user equipment (UE); and
obtain, in accordance with the scheduling request configuration, a scheduling request for a first logical channel of the one or more logical channels based at least in part on a first parameter of the set of parameters satisfying a selected threshold for the first parameter, wherein the selected threshold is within a first range of the plurality of ranges associated with the first parameter.

14. The network entity of claim 13, wherein:
the first range of the plurality of ranges comprises a range of quantities for a scheduling request count,
the range of quantities for the scheduling request count is based at least in part on a traffic pattern at the UE, a machine learning algorithm, or both.

15. The network entity of claim 13, wherein:
the first range of the plurality of ranges comprises a range of scheduling request prohibit timer durations,
the range of scheduling request prohibit timer durations is based at least in part on a traffic pattern at the UE, a machine learning algorithm, or both.

16. The network entity of claim 13, wherein:
the scheduling request for the first logical channel comprises a predictive scheduling request, and
the scheduling request is obtained based at least in part on a traffic type, a periodicity of uplink traffic, or both at the UE.

17. The network entity of claim 13, wherein, to obtain the scheduling request, the one or more processors are individually or collectively operable to execute the code to cause the network entity to:
obtain the scheduling request in accordance with a first type of data at the UE, a first type of activity at the UE of a plurality of types of activities, or both, wherein: the first type of data comprises uplink data, and the plurality of types of activities comprise a beam failure recovery (BFR) procedure, a listen-before-talk (LBT) procedure, a delay status reporting (DSR) procedure, or any combination thereof.

18. The network entity of claim 13, wherein the scheduling request configuration is associated with the one or more logical channels and a first bandwidth part (BWP), and the one or more processors are individually or collectively further operable to execute the code to cause the network entity to:
output a second scheduling request configuration comprising a second indication of a second plurality of ranges associated with the respective parameters of the set of parameters, the second scheduling request configuration associated one or more second logical channels of the plurality of logical channels of the UE and a second BWP.

19. The network entity of claim 13, wherein the first parameter of the set of parameters comprises a scheduling request count, and the one or more processors are individually or collectively further operable to execute the code to cause the network entity to:
obtain, in accordance with the scheduling request configuration, a second scheduling request for the first logical channel based at least in part on the first parameter of the set of parameters satisfying a second selected threshold for the first parameter, wherein: the second selected threshold is within the first range of the plurality of ranges associated with the first parameter, the second selected threshold is larger than the selected threshold, and the second selected threshold is based at least in part on a quality of service (QoS) policy associated with a traffic flow of the UE.

20. A method for wireless communications at a user equipment (UE), comprising:
receiving, from a network entity of a serving cell of the UE, signaling indicating a scheduling request configuration comprising an indication of a plurality of ranges associated with respective parameters of a set of parameters, the scheduling request configuration associated one or more logical channels of a plurality of logical channels of the UE;
transmitting, in accordance with the scheduling request configuration, a scheduling request for a first logical channel of the one or more logical channels based at least in part on a first parameter of the set of parameters satisfying a selected threshold for the first parameter, wherein the selected threshold is within a first range of the plurality of ranges associated with the first parameter; and
monitoring for a scheduling grant associated with the first logical channel based at least in part on the scheduling request.
